(19) United States
(12) Patent Application Publication
(10) Pub. No.: US 2025/0130540 A1
(43) Pub. Date: Apr. 24, 2025

(54) METHOD FOR CALCULATING A PARAMETERIZATION OF A CONTROLLER FOR A TECHNICAL SYSTEM

(71) Applicant: Robert Bosch GmbH, Stuttgart (DE)

(72) Inventors: Felix Berkel, Schifferstadt (DE); Kim Peter Wabersich, Schwaebisch Gmuend (DE); Maximilian Steeb, Weinstadt (DE); Sven Reimann, Renningen (DE)

(21) Appl. No.: 18/912,176

(22) Filed: Oct. 10, 2024

(30) Foreign Application Priority Data
Oct. 19, 2023 (DE) 10 2023 210 262.5

(51) Int. Cl. G05B 13/04

(52) U.S. Cl. CPC G05B 13/042

(57) ABSTRACT

A method for calculating a parameterization of a controller for a technical system. The method includes: determining a characteristic of the controller, wherein the characteristic includes at least a description of a structure of the controller and at least one differential equation to represent a dynamic behavior of the technical system; defining an objective function which is based on at least one requirement for a safety characteristic and/or for a performance characteristic of the controller and/or of the technical system; formulating an optimization problem, wherein the optimization problem is formulated on the basis of the objective function and at least one additional condition, wherein the at least one additional condition ensures at least one restriction of at least one state of the technical system; calculating the parameterization of the controller based on the determined optimization problem.

### FIELD

The present invention relates to a method for calculating a parameterization of a controller for a technical system. The present invention furthermore relates to a controller, a computer program, a device and a storage medium for this purpose.

### BACKGROUND INFORMATION

The current approach to calibrating controllers, especially for autonomous driving functions, largely relies on manual parameter settings. However, this approach not only requires extensive expert knowledge but also offers no prior guarantees that performance and safety standards will be met. The validation of these standards is usually done post hoc, through complex simulations and test drives, which are both time-consuming and costly. If the initially selected calibration is not able to meet the performance and/or safety requirements, these manual calibration methods lack a standardized, systematic approach to optimization. Such cases require the involvement of an experienced expert, who must carry out the calibration again, with a comparable expenditure of resources. Only thereafter can the empirical verification of compliance with the performance and safety requirements take place again.

There are numerous methods for controller parameterization (e.g., Ziegler-Nichols method for parameterizing PID controllers). The common methods often have to be implemented step by step on the actual system, which involves costs and effort. In addition, expert knowledge of the application and the control is sometimes required. For multivariable systems, some methods cannot be used at all. In addition to good performance, such as comfort for the driver or good steering behavior, safety is also a key aspect for autonomous driving functions. This means that the control deviation must not exceed a certain threshold value, for example in order to ensure that the vehicle does not leave the lane, thus avoiding collisions. Such requirements are not explicitly taken into account in the traditional parameterization methods and must be proven by complex simulations and test drives. In the related art, parameterization is therefore only carried out through practical tests on the actual technical system.

### SUMMARY

The present invention relates to a method, to a controller, to a computer program, to a device, and to a computer-readable storage medium. Example embodiments of, features of and details relating to the present invention can be found in the disclosure herein. Features and details described in connection with the method according to the present invention of course also apply in connection with the controller according to the present invention, the computer program according to the present invention, the device according to the present invention, and the computer-readable storage medium according to the present invention, and in each case vice versa, so that, with respect to the disclosure, mutual reference is or can be made to the individual aspects of the present invention at all times.

The subject matter of the present invention is in particular a method for calculating a parameterization of a controller for a technical system. According to an example embodiment of the present invention, the method includes the following steps, wherein the steps can be carried out repeatedly and/or successively.

In a first step, a characteristic of the controller is preferably determined, wherein the characteristic comprises at least a description of a structure of the controller and at least one differential equation in order to represent a dynamic behavior of the technical system by means of the differential equation. The at least one differential equation is preferably data-based, i.e., in particular provided with specific values, for which an identification method can be carried out in order to identify parameters of the at least one differential equation. For this purpose, the technical system can, for example, be excited by excitation signals in order subsequently to carry out measurements on or by means of the technical system.

In a further step, an objective function is preferably defined, wherein the objective function is based on at least one requirement for a safety characteristic and/or for a performance characteristic of the controller and/or of the technical system. In the context of the present invention, the safety characteristic may also be referred to and understood as a safety requirement. The safety characteristic relates, for example, to safety of a user of the technical system. For example, the safety may be vehicle safety if the technical system is designed as a vehicle. In the context of the present invention, the performance characteristic may also be referred to and understood as a performance requirement. The performance characteristic may, for example, specify a type of control, whereby a controller with different properties in terms of performance, robustness, agressivity, comfort, optimality, steering behavior and disturbance variable suppression can be provided, for example.

In a further step, an optimization problem is preferably formulated, wherein the optimization problem is formulated on the basis of the objective function and at least one additional condition, wherein the at least one additional condition ensures at least one restriction of at least one state of the technical system. The term “formulating” may also be understood as determining the optimization problem. The optimization problem may also be referred to and understood as an optimization task. In other words, the restriction is intended to ensure that the at least one state of the technical system does not exceed a certain threshold value. This threshold value may be specified by a requirement or determined as part of the optimization. The restriction can advantageously ensure that the control is robust against disturbances.

In a further step, the parameterization of the controller is preferably calculated on the basis of the formulated optimization problem. For this purpose, various optimization methods described in the related art can be used.

The method thus advantageously allows efficient parameterization of the controller without time-consuming manual calibration routines. Furthermore, the at least one requirement for the safety characteristic and/or the performance characteristic can advantageously be taken into account in the parameterization.

Moreover, within the scope of the present invention, it is optionally possible for the at least one state to reflect a temporal behavior of a corresponding controlled variable of the controller and in particular to indicate a current value of the corresponding controlled variable. In the example of a vehicle as a technical system, the controlled variable may, for example, be a yaw angle error of the vehicle.

The restriction of the at least one state of the technical system can be ensured by the controller controlling the at least one state in such a way that a value of the at least one state remains in an invariant set. An invariant set is in particular characterized in that, if a state vector is in the invariant set, the subsequent state vector is also in this set. This can advantageously ensure that the control error of the at least one state does not exceed critical threshold values and that a particular requirement for the safety characteristic is thus, for example, ensured.

Furthermore, according to an example embodiment of the present invention, it can be provided that the at least one state is controlled by the controller in such a way that a value of the state under disturbance variables limited by ellipsoidal or polytopic sets remains in an invariant set.

According to a further possibility of the present invention, it can be provided that the characteristic of the controller furthermore defines a type of restriction of the state of the technical system, wherein the type is preferably based on an ellipsoid function or a polytope function. The ellipsoid function and the polytope function can be particularly advantageous for restricting the state of the technical system and, depending on the application, the ellipsoid function or the polytope function may be more suitable and selected accordingly.

Optionally, it is possible that defining the objective function comprises the following step:
determining a limit value or a limit range for the at least one state on the basis of the at least one requirement for the safety characteristic and/or for the performance characteristic of the controller and/or of the technical system.

A specific and application-dependent limit value or limit range, which is not to be exceeded, can thus advantageously be defined for the at least one state. Accordingly, restricting the at least one state can be carried out on the basis of the determined limit value or limit range.

For example, according to an example embodiment of the present invention, it may be provided that the at least one additional condition furthermore defines a threshold value for the at least one state and/or for at least one input variable of the controller, wherein the defined threshold value according to the additional condition must not be exceeded. A specific and application-dependent threshold value, which is not to be exceeded, can thus advantageously be defined for the at least one state or the at least one input variable. This can be ensured by calculating the parameterization on the basis of the optimization problem. For example, an additional state of the at least one state and/or additionally the at least one input variable can thus advantageously be taken into account.

It may optionally be provided according to an example embodiment of the present invention that formulating the optimization problem furthermore comprises the following step:
defining a cost function, wherein the cost function assigns a weighting value to the at least one state as part of calculating the parameterization in order to provide prioritization of states.

This allows the agressivity or reaction of the controller to be advantageously adjusted, for example. Taking the cost function into account, for example, allows comfort to be taken into account more strongly as a performance characteristic in the controller parameterization and thereby, in particular, to influence a form of the invariant set as well.

It is possible that the at least one differential equation is a linear differential equation and that the dynamic behavior of the technical system is represented by a combination of the at least one differential equation with at least one further linear differential equation. This allows a linear differential inclusion to be present or to be carried out.

Furthermore, according to an example embodiment of the present invention, it may be provided that the characteristic of the controller is determined in such a way that values, in particular measurements, of all states are taken into account, i.e., that state feedback is in particular provided, or that values, in particular measurements, of some of the states are taken into account, i.e., that output feedback is in particular provided.

According to an example embodiment of the present invention, it may optionally be possible for the method to furthermore comprise the following step:
implementing the parameterized controller on the technical system.

The technical system is preferably a vehicle, and the controller is preferably used for lateral and/or longitudinal control of the vehicle. It is thus possible for the method according to the present invention to be used in a vehicle. The vehicle may be configured, for example, as a motor vehicle and/or passenger vehicle and/or autonomous vehicle. The vehicle may comprise a vehicle mechanism, for example for providing an autonomous driving function and/or a driver assistance system. The vehicle mechanism may be designed to at least partially automatically control and/or accelerate and/or brake and/or steer the vehicle.

The present invention also relates to a controller for a technical system, wherein the controller is configured to perform the method according to the present invention or to be used within the framework of the method according to the present invention.

The present invention also relates to a computer program, in particular a computer program product, comprising commands which, when the computer program is executed by a computer, cause the computer to carry out the method according to the present invention. The computer program according to the present invention thus delivers the same advantages as have been described in detail with reference to a method according to the present invention.

The present invention also relates to a device for data processing that is configured to carry out the method according to the present invention. For example, a computer which executes the computer program according to the present invention can be provided as the device. The computer can have at least one processor for executing the computer program. A non-volatile data memory can also be provided, in which the computer program is stored and from which the computer program can be read by the processor for execution.

The present invention can also relate to a computer-readable storage medium which comprises the computer program according to the present invention and/or commands which, when executed by a computer, cause the computer to carry out the method according to the present invention. The storage medium is formed, for example, as a data memory such as a hard drive and/or a non-volatile memory and/or a memory card. The storage medium can be integrated into the computer, for example.

Furthermore, the method according to the present invention can also be carried out as a computer-implemented method.

Further advantages, features and details of the present invention can be found in the following description, in which exemplary embodiments of the present invention are described in detail with reference to the figures. The features mentioned herein can be essential to the present invention, individually or in any combination.

### BRIEF DESCRIPTION OF THE DRAWINGS

FIG. 1 is a schematic visualization of a method, a controller 1, a technical system, a device, a storage medium and a computer program according to exemplary embodiments of the present invention,

FIG. 2 is a schematic representation of a structure for lateral control according to exemplary embodiments of the present invention.

FIG. 3 is a schematic visualization of an ellipsoid function and a polytope function according to exemplary embodiments of the present invention.

FIG. 4 is a schematic visualization of a flowchart of a method for controller parameterization according to exemplary embodiments of the present invention.

### DETAILED DESCRIPTION OF EXAMPLE EMBODIMENTS

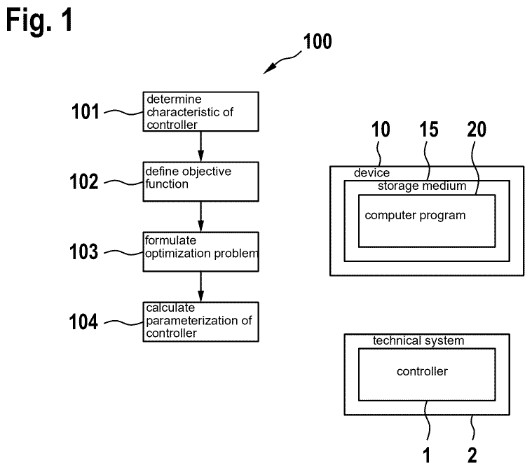

FIG. 1 schematically shows a method 100, a controller 1, a technical system 2, a device 10, a storage medium 15 and a computer program 20 according to exemplary embodiments of the present invention.

FIG. 1 in particular shows an exemplary embodiment of a method 100 for parameterizing a controller 1 for a technical system 2, comprising the following steps. In a first step 101, a characteristic of the controller 1 is determined, wherein the characteristic comprises at least a description of a structure of the controller 1 and at least one differential equation in order to represent a dynamic behavior of the technical system 2 by means of the differential equation. In a second step 102, an objective function is defined, wherein the objective function is based on at least one requirement for a safety characteristic and/or for a performance characteristic of the controller 1 and/or of the technical system 2. In a third step 103, an optimization problem is formulated, wherein the optimization problem is formulated on the basis of the objective function and at least one additional condition, wherein the at least one additional condition ensures at least one restriction of at least one state of the technical system 2. In a fourth step 104, the parameterization of the controller 1 is calculated on the basis of the determined optimization problem.

The present invention in particular presents a method which parameterizes a controller 1, for example a lateral controller, based on invariant sets. Using a dynamic model of a technical system 2, such as a vehicle, controller parameters can be adjusted efficiently without time-consuming manual calibration routines. In doing so, maximum control deviations of different states of the technical system 2 (e.g., lateral errors) can be explicitly taken into account and safety requirements can thus be met. Performance requirements (e.g., avoiding excessive steering angles for increased comfort) can likewise also be taken into account. If there are multiple performance requirements, they can also be prioritized using weightings. The method can in particular be used for different controllers 1 for which a dynamic model of the technical system 2 is available.

The method according to exemplary embodiments of the present invention can offer various advantages. The method according to exemplary embodiments in particular allows efficient parameterization of the controller 1 without time-consuming manual calibration routines. Furthermore, maximum control deviations of different states of the system can be explicitly taken into account and safety requirements can thus be guaranteed. Disturbance variables and their impact on the technical system 2 can be explicitly taken into account in the parameterization. Model uncertainties can be explicitly taken into account in the method using linear differential inclusion (LDI). The method according to exemplary embodiments can, for example, be used for univariable systems (SISO: single-input single-output) and also multivariable systems (MIMO: multiple-input multiple-output). By means of the method according to exemplary embodiments, the performance of the technical system 2 can be flexibly adapted to different target criteria. By minimizing the robust invariant set, the controller 1 can be parameterized such that the control error is minimized. By maximizing the robust invariant set while maintaining maximum control errors, a less aggressive controller 1, i.e., for example, a high level of comfort, can be realized while still ensuring safety. With the help of a cost function, individual states and inputs can also be weighted and the performance can thus be adjusted individually.

For control functions in the field of autonomous driving, hardware, such as sensors and actuators, and a structure of the control function may already be known, and the controller 1 must be parameterized according to the requirements. The presented method according to exemplary embodiments can, for example, be used at this point. The method can also be used in the field when recalibration of the controller 1 is required, for example due to aging of the technical system 2. The method can also be used as a service for a customer. If the customer is not satisfied with the behavior of the technical system 2, in particular of the vehicle, the method can be used to recalibrate the controller 1 according to the customer requirements.

In the following, the method is explained using the example of the lateral control of a vehicle, in particular an autonomous vehicle. However, the lateral control is an application example and the method is in particular not limited thereto, but the method can generally be applied to different calibration tasks of controllers 1.

The model for the lateral control is preferably derived from a linearized single-track model.

For example, the following state vector x=[ψₑ, \dot{ψ}ₑ, β, yₑ, int(yₑ), δ, \dot{δ}]^{T} is defined, where ψₑ is a yaw angle error of the vehicle, β is a side slip angle of the vehicle, yₑ is a lateral error, int(yₑ) is an integrated lateral error, and δ is a steering angle of the vehicle.

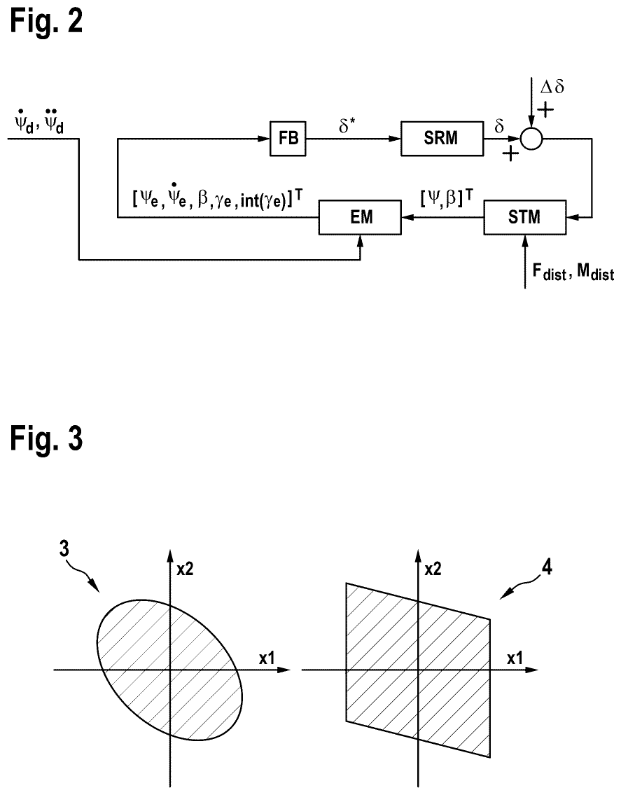

For the lateral control, it is, for example, possible to derive a state space model according to FIG. 2, which comprises the steering reference model (SRM), the linearized single-track model (STM), the lateral error model (EM), and the feedback controller 1 (FB).

The state space model is in particular given in the form

$$\begin{matrix}\dot{x} = {A}_{c} x + {B}_{c} u + {E}_{c} w \\ y = Cx\end{matrix}$$

with the state vector x=[ψₑ, \dot{ψ}ₑ, β, yₑ, int(yₑ), δ, \dot{δ}]^{T} of the input variable u=δ* (target steering angle). The disturbance variable vector w preferably combines the angle error Δδ, force and torque disturbances on the vehicle F_{dist}, M_{dist}, and the reference trajectory of the yaw angle \dot{ψ}_{d}, \ddot{ψ}_{d}.

The controller 1 is then in particular given by δ*=K₁·ψₑ+K₂·\dot{ψ}ₑ+K₃·yₑ+K₄·int(yₑ). In general, this may mean that not the entire state vector but only the output y=Cx is fed back. This generally results in particular in the control law

u=Ky=KCx

Since the control can be implemented on a control unit and the controller 1 can thus be executed in a time-discrete manner, the state space model is preferably discretized for the parameterization of the controller parameters.

This, for example, results in the discretized state space model

$$\begin{matrix}x ( k + 1 ) = A x ( k ) + B u ( k ) + E w ( k ) \\ y ( k ) = C x ( k )\end{matrix}$$

which can be a basis for the method according to exemplary embodiments of the present invention. This in particular represents the dynamic behavior of the technical system 2. In addition to physical variables, the state vector x may also contain states of the controller 1, such as the integrated lateral error in the case of the lateral control. This means, for example, that a wide variety of control structures can be brought into such a form and that the method is thus advantageously very universally applicable.

If parametric uncertainties exist, the system can be modeled as a linear difference inclusion (LDI).

$$\begin{matrix}x ( k + 1 ) ∈ \{ A x ( k ) + B u ( k ) + E w ( k ) \vert ( A , B , E ) ∈ c o ( Ω ) \} \\ Ω = \{ ( {A}_{i} , {B}_{i} , {E}_{i} ) , i = 1 , … , q \}\end{matrix}$$

co(Ω) preferably describes the operator of the convex hull. This in particular means that the parametrically uncertain system matrix A is given by a combination of the corner matrices

$$A = {\sum }_{i = 1}^{q} {α}_{i} {A}_{i} \vert {\sum }_{i = 1}^{q} {α}_{i} = 1 , {α}_{\dot{l}} \geq 0 ∀ i ∈ \{ 1 , … , q \}$$

This can likewise also apply to the input matrices B and E.

A goal of the present invention according to exemplary embodiments may be to provide such a parameterization of the controller 1 so that guarantees can be given that, for example, the control error does not exceed a certain threshold value. For this purpose, the aforementioned state space model can be designed such that the relevant control error occurs as a state in the state vector x. One concept for being able to provide such guarantees is so-called invariant sets, for example. An invariant set M is characterized in particular in that, if a start state vector is in the set x(k)ϵM, the subsequent state vector is also in this set x(k+1)ϵM, taking into account possible disturbance variables and model uncertainties. This can ensure that the control error does not exceed critical threshold values and that safety is thus ensured.

An invariant set may inter alia be described as an ellipsoid function 3 or as a polytope function 4, as outlined in FIG. 3, where x1 and x2 are each exemplary states of the technical system 2.

An ellipsoid function 3 is in particular mathematically described by

$$ℰ = \{ x \vert {x}^{T} Px \leq 1 \}$$

with the positive definite matrix P. A polytope function 4 can be described by

$$Υ = \{ x \vert {H}_{i} x \leq 1 , i ∈ \{ 1 , … , h \} \}$$

where Hᵢx≤1 describes a half-space. Alternatively, a polytope may also be described by the vertices vᵢ, i.e.,

$$Υ = \{ x = {\sum }_{i = 1}^{p} {α}_{i} {v}_{i} \vert {\sum }_{i = 1}^{p} {α}_{i} = 1 , {α}_{i} \geq 0 ∀ i ∈ \{ 1 , … , p \} \}$$

with the vertex space vert(γ)={v₁, . . . , vₚ}.

The basis of the method according to exemplary embodiments is in particular the following condition for the robust positive invariance (RPI):

$$∀ x ( k ) ∈ ℰ , ∀ w ( k ) ∈ W : x ( k + 1 ) ∈ ℰ$$

Here, the condition is given, for example, for elliptic robust invariant sets. This condition in particular means that, for each state x(k)ϵE in the invariant set E and with a limited disturbance variable w(k)ϵW, the state for all further steps remains in the invariant set ε, i.e., x(k+1)Σε. The set of possible disturbance variables W can be given by an ellipsoid or by a polytope.

The condition x(k)ϵε can also be given by

$${( \begin{matrix}x \\ 1\end{matrix} )}^{T} ( \begin{matrix}- P & 0 \\ 0 & 1\end{matrix} ) ( \begin{matrix}x \\ 1\end{matrix} ) \geq 0$$

Below, for the sake of clarity, the following simplification in notation is made:

$$( \begin{matrix}A & {B}^{T} \\ B & C\end{matrix} ) = ( \begin{matrix}A & * \\ B & C\end{matrix} )$$

The method for parameterizing the controller 1 according to exemplary embodiments of the present invention, in particular with a given structure of the controller 1, is described below.

Different criteria may be important for the parameterization of the controller 1. Six exemplary criteria are introduced below, which can be linked together according to the requirements of the control task. How these criteria can be taken into account in determining the controller gain is explained thereafter.

The following criteria can be distinguished. Criterion 1 may be a type of the restriction of the disturbance variables (e.g., polytopic or ellipsoidal). Criterion 2 may be a guaranteed compliance with state restrictions and input restrictions. Criterion 3 may be a consideration of a cost function. Criterion 4 may be a distinction as to whether the controller 1 is provided with output feedback, i.e., u=KCx, instead of state feedback, i.e., u=Kx. Criterion 5 may be a target variable of the optimal controller parameterization. Criterion 6 may be a consideration of parametric model uncertainties.

First, it is preferably assumed that the entire state vector x is fed back, i.e., u=Kx or C corresponds to the unit matrix.

Criterion 1: By means of the mathematical conditions formulated below, the controller 1 can be parameterized such that, under the occurrence of disturbances, the state vector remains in an invariant set. This ensures that the control is robust against the disturbance.

In the case of elliptically restricted disturbance variables, the set of possible disturbance variables w can here be given by

$$W = \{ w \vert {w}^{T} Tw \leq 1 \}$$

Using the difference equation for elliptically restricted disturbance variables, the condition x(k+1)ϵε can be transformed into

$${( \begin{matrix}x \\ w \\ 1\end{matrix} )}^{T} ( \begin{matrix}- {( A + BK )}^{T} P ( A + BK ) & * & * \\ - {E}^{T} P ( A + BK ) & - {E}^{T} PE & * \\ 0 & 0 & 1\end{matrix} ) ( \begin{matrix}x \\ w \\ 1\end{matrix} ) \geq 0 , ∀ {w}^{T} Tw \leq 1$$

After mathematical transformations, the condition for robust positive invariance can be given by

$$( \begin{matrix}μ ( S + {S}^{T} - X ) & * & * \\ 0 & λ T & * \\ AS + BY & E & X\end{matrix} ) \geq 0$$

$$1 - μ - λ \geq 0 , μ > 0 , λ > 0$$

This is in particular a so-called linear matrix inequality (LMI), for which there are, for example, efficient optimization algorithms for solving it. By solving this LMI, the matrices X>0, S and Y can be determined. The controller parameterization results in particular from K=YS⁻¹, and the ellipsoid is in particular parameterized by P=X⁻¹.

In the case of polytopically restricted disturbance variables, using the difference equation for polytopically restricted disturbance variables, i.e., the set of possible disturbance variables is preferably given by the vertices of the polytope, the condition x(k+1)ϵε can be transformed into

$${( \begin{matrix}x \\ 1\end{matrix} )}^{T} ( \begin{matrix}- {( A + BK )}^{T} P ( A + BK ) & * \\ - {w}^{T} {E}^{T} P ( A + BK ) & 1 - {w}^{T} {E}^{T} PEw\end{matrix} ) ( \begin{matrix}x \\ 1\end{matrix} ) \geq 0 , ∀ w ∈ vert ( W )$$

After mathematical transformations, the condition for robust positive invariance can be given by

$$( \begin{matrix}μ ( S + {S}^{T} - X ) & * & * \\ 0 & 1 - μ & * \\ AS + BY & Ew & X\end{matrix} ) \geq 0 , ∀ w ∈ vert ( W ) , μ > 0$$

By solving this LMI, the matrices X>0, S and Y can be determined. The controller parameterization results in particular from K=YS⁻¹, and the ellipsoid describing the invariant set is in particular parameterized by P=X⁻¹.

Criterion 2: If, for example, the absolute yaw angle error must not exceed a maximum value eₘₐₓ, this can be described with the state vector x=[ψₑ, \dot{ψ}ₑ, β, yₑ, int(yₑ), δ, \dot{δ}]^{T} through the following two conditions

$$\begin{matrix}[ 1 / {e}_{max} , 0 , … , 0 ] x \leq 1 \\ [ - 1 / {e}_{max} , 0 , … , 0 ] x \leq 1\end{matrix}$$

In this way, a safety limit can be defined for each relevant state. Such conditions can be combined in the following set:

$${ϒ}_{x} = \{ x \vert {H}_{i} u \leq 1 , i ∈ \{ 1 , … , {n}_{x} \} \}$$

In order to ensure that this can always be maintained, the invariant set ε may be a subset of γₓ, εϵγₓ. This can be described mathematically by the following condition

$$( \begin{matrix}1 & {H}_{i} X \\ {( {H}_{i} X )}^{T} & X\end{matrix} ) \geq 0 , ∀ i ∈ \{ 1 , … , {n}_{x} \}$$

In combination with the conditions of criterion 1, a controller 1 can advantageously be parameterized in such a way that exceeding maximum control deviations is robustly ensured.

Compliance with input restrictions (or actuator restrictions) can also be ensured by formulating appropriate additional conditions. Input restrictions are given, for example, in polytopic form:

$${ϒ}_{u} = \{ u \vert {G}_{i} u \leq 1 , i ∈ \{ 1 , … , {n}_{u} \} \}$$

In order to ensure that this can always be maintained, the invariant set ε may be a subset of γᵤ, εϵγᵤ. This can be described by the following condition

$$( \begin{matrix}1 & {G}_{i} Y \\ {( {G}_{i} Y )}^{T} & S + {S}^{T} - X\end{matrix} ) \geq 0 , ∀ i ∈ \{ 1 , … , {n}_{u} \} .$$

Compliance with the input restrictions within the invariant set can thus be explicitly taken into account in the calibration. The same optimization variables X>0, S and Y as in criterion 1 can occur for the additional conditions for compliance with state restrictions and input restrictions, so that they can be directly combined with one another.

Criterion 3: In order to be able to take into account a requirement regarding a performance characteristic, for example comfort, in the parameterization of the controller 1, a cost function can be defined. This allows the agressivity of the controller 1 to be adjusted, and the states (e.g., the transverse error) can be weighted differently, which involves a kind of prioritization.

In general, the cost function can be given by

$$J = {\sum }_{k = 0}^{N} {x}^{T} ( k ) {Q}_{x} ( k ) + {u}^{T} ( k ) Ru ( k )$$

with the positive definite weighting matrices Q and R, which are, for example, diagonal matrices.

By appropriate mathematical transformations, the following condition in particular results

$$( \begin{matrix}μ ( S + {S}^{T} - X ) & * & * & * \\ 0 & λ T & * & * \\ AS + BUC & E & X & * \\ {( \begin{matrix}Q & 0 \\ 0 & R\end{matrix} )}^{1 / 2} ( \begin{matrix}S \\ Y\end{matrix} ) & 0 & 0 & I\end{matrix} ) \geq 0$$

$$1 - μ - λ \geq 0 , μ > 0 , λ > 0$$

which ensures the robust positive invariance of the ellipsoid ε under elliptically restricted disturbance variables, wherein the cost function J is preferably to be minimized. By solving this LMI, the matrices X>0, S and Y can be determined. The controller parameterization results in particular from K=YS⁻¹, and the ellipsoid is in particular parameterized by P=X⁻¹.

For polytopically restricted disturbance variables, the LMI additional condition can be adjusted according to criterion 1 so that a cost function is taken into account here in addition to polytopically restricted disturbance variables.

The consideration of a cost function can allow a requirement for the performance characteristic, for example comfort, to be taken into account in the controller parameterization and the form of the invariant set to be influenced.

Criterion 4: In general, it is in particular not always possible to measure all states, or not all states are taken into account in the control law, i.e., u=KCx. An additional condition can therefore be formulated, which allows parameterization of the controller 1 under incomplete state feedback. For elliptically restricted disturbance variables, the same approach as in criterion 1 is preferably followed in this case. By solving the following condition

$$( \begin{matrix}μ ( S + {S}^{T} - X ) & * & * \\ 0 & λ T & * \\ AS + BUC & E & X\end{matrix} ) \geq 0$$

$$VC = CS$$

$$1 - μ - λ \geq 0 , μ > 0 , λ > 0$$

a robust invariant set can be determined, wherein the matrices X>0, S, V and U are in particular determined. The controller parameterization results in particular from K=UV⁻¹, and the ellipsoid is in particular parameterized by P=X⁻¹. This procedure for taking output feedback into account can also be used in combination with further criteria.

Criterion 5: Depending on the specific application, different target variables may be important. The following describes possible target variables according to exemplary embodiments and how they can be combined with criteria 1-4. The target variable is preferably optimized, i.e., in particular minimized, in the formulated optimization problem.

If the influence of the disturbance variable is to be compensated as much as possible, minimizing the robust invariant set is a possible target variable. The volume of the ellipsoid ε={x|x^{T}Px≤1} is in particular proportional to (det P)^{-1/2}. It is thus possible to minimize the volume of the ellipsoid by minimizing −logdet P. Alternatively, the trace of the matrix P, which corresponds to the sum of the squared semi-axes of the ellipsoid, can be used. By minimizing −SpurP, the size of the ellipsoid is thus also minimized. Since the optimization variable X=P⁻¹ is in particular given in the aforementioned conditions, the objective function SpurX can be used to minimize the robust invariant set. This objective function can in particular be advantageous in combination with the conditions of criterion 1. Minimizing the robust invariant set can result in an aggressive controller 1.

For higher-dimensional systems with more than three to five states, global minimization of the volume of the invariant set for a specific application may produce undesirable results since, for example, disproportionate controller deviations in individual states would result in the smallest overall volume.

In such cases, the extension of the invariant set in specified directions DᵢΣRⁿ, i=1, 2, . . . , n_{d} can be specifically minimized, wherein |Dᵢ| proportionally weights a minimization toward Dᵢ. For formulating such a cost function, maximum extensions dᵢ of the invariant set ε in the directions Dᵢ can be formulated in a first step as the following condition

$$( \begin{matrix}{d}_{i} & {D}_{i} X \\ {( {D}_{i} X )}^{T} & X\end{matrix} ) \geq 0 , ∀ i ∈ \{ 1 , … , {n}_{d} \} .$$

This condition can make it possible in a second step to minimize ε directly in the corresponding expansion directions Dᵢ by means of the objective function Σᵢdᵢ.

The maximization of the robust invariant set can be realized in the optimization problem by the objective function −logdet X or −Spur X. This maximum robust invariant set is determined, for example, such that, according to the requirements, maximum control deviations are still ensured by the conditions of criterion 2. The invariance of the set can be ensured by the conditions of criterion 1. Such a procedure makes it possible to determine a tendentially less aggressive controller 1, i.e., in particular a higher level of comfort, while still ensuring safety.

If a cost function is defined, it must in particular be minimized, which can be realized through the objective function Spur P or −SpurX. This minimizes, for example, an upper limit of the cost function. In order to ensure robust invariance, the condition of criterion 3 can also be taken into account. In general, this objective function can result in maximization of the robust invariant set. By increasing the weighting matrices Q and R, the volume of the invariant set can be reduced. In addition, the weighting matrices can be used to influence the performance characteristic (i.e., for example, disturbance variable suppression or comfort). This can also influence the form of the invariant set. In addition, the conditions of criterion 2 can be included in the optimization in order to ensure maximum control deviations.

If there is only one output feedback, the conditions can be adjusted according to criterion 4. This can be combined with all objective functions of criterion 5.

Criterion 6: If parametric uncertainties exist and the uncertain model is described as a linear difference inclusion (LDI), the linear matrix inequalities can be formulated for all q corner matrices of the LDI. This procedure can be combined with all of criteria 1-4.

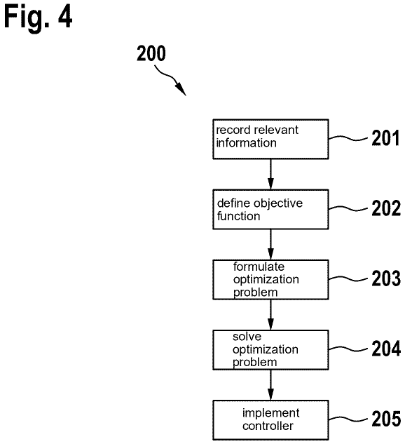

FIG. 4 shows the sequence of a method 200 for controller parameterization according to an exemplary embodiment.

In a first step 201, all relevant information is recorded. The following information can be provided in order to use it as a basis for applying the method according to exemplary embodiments. The technical system 2 to be controlled can be described by means of data-based differential equations, which represent the dynamic behavior (e.g., modeling of the lateral dynamics on the basis of the linearized differential equation of the single-track model and its identification). The differential equation of the single-track model can, for example, be formulated first as described above. This is preferably done based on appropriate physical equations. Then, the parameters of the differential equation can be identified by appropriate identification methods. This is done, for example, based on measurements of the technical system 2, in particular vehicle measurements. In the cycles run thereon, the parameters to be identified can be sufficiently excited. Furthermore, a mathematical description of the controller structure may be provided, preferably in a non-parameterized manner. The structure of the lateral control can be described by mathematical equations. These equations may be dynamic and/or static equations. This is preferably done in a time-discrete form. Furthermore, an overall model of the technical system 2 to be controlled and of the controller 1 can be formulated in the following form

$$\begin{matrix}x ( k + 1 ) = Ax ( k ) + Bu ( k ) + Ew ( k ) \\ y ( k ) = Cx ( k )\end{matrix}$$

including the parameterization of A, B, E and C. The differential equations of the lateral dynamics are in particular discretized with a sampling time used and are combined with the equations of the lateral control in an overall system. This allows the technical system 2 of the lateral dynamics and the control structure to be combined in a difference equation such that the part of the control that is to be parameterized can be represented by u=Ky. If dynamic controllers 1 with their own states, such as a PI controller 1, are used, the overall order can increase as compared to the order of the lateral dynamics. In addition, the restrictions of the disturbance w can be mathematically described by a polytope or ellipsoid. In doing so, the value ranges in which the disturbances occur must in particular be identified. For example, for the lateral control, it is relevant to know the maximum transverse disturbance force acting on the vehicle.

In a further step 202, the objective function is defined. In doing so, a target value of criterion 5 must, for example, be defined, depending on the requirements of the control task. It may be relevant which safety requirements must be met or which requirements are given for a performance characteristic, such as comfort. A maximum permissible lateral transverse error yₑ can, for example, be defined for the lateral control. In addition, limits for the steering angle δ and its derivative \dot{δ} can be defined in order to ensure a certain level of comfort. These requirements can be taken into account in the controller parameterization through the additional condition according to criterion 2. In order to obtain a controller 1 that is not unnecessarily aggressive, which may, for example, be unpleasant for a driver of the vehicle, the invariant set can be maximized while complying with the defined limits. Alternatively, the goal may be to minimize the lateral error, if accurate lateral tracking is important.

In a further step 203, an optimization problem is preferably formulated. According to the requirements for the controller 1, relevant additional conditions of criteria 1 to 4 and 6 must in particular be defined. In addition to the mathematical description of the objective function, further additional conditions can be formulated here. These additional conditions in particular ensure that the controller parameters are optimized such that a robust invariant set corresponding to the objective function results. An additional condition according to criterion 1 may be required, depending on the type of the set of the disturbance, such as a transverse disturbance force on the transverse control by the wind, which would be described polytopically. From criterion 5, an objective function can be defined. In order to be able to provide guarantees on the maximum deviations of individual states such as the lateral error, criterion 2 can be used. Criterion 4 can also be used in the lateral control exemplary embodiment since an output feedback can be present here. If a cost function is to be minimized, criterion 3 can be taken into account. Often, there may be parameter uncertainties, such as a varying mass of the vehicle, which can be integrated through criterion 6. This in particular results in an optimization problem which comprises an objective function and a number of additional conditions.

In a fourth step 204, the optimization problem is preferably solved. For this purpose, an appropriate optimization tool, of which various examples are described in the related art, can be used, and the parameterization of the controller 1 can thus be calculated.

In a fifth step 205 according to this exemplary embodiment, the controller 1 can be implemented in the technical system 2, for example in a control unit of a vehicle. After the controller parameterization has been calculated, the controller 1 can accordingly be implemented in the control unit, or a new parameterization can be loaded into the control unit. After commissioning of the controller 1 in the actual technical system 2, for example a vehicle, with the optimized parameterization, it can also be evaluated whether the required guarantees can be met.

The above description of the embodiments describes the present invention exclusively in the context of examples. Of course, individual features of the embodiments, provided they make technical sense, can be freely combined with one another without departing from the scope of the present invention.

1-13. (canceled)

14. A method for calculating a parameterization of a controller for a technical system, the method comprising the following steps:
determining a characteristic of the controller, wherein the characteristic includes at least a description of a structure of the controller, and at least one differential equation to represent a dynamic behavior of the technical system by the differential equation;
defining an objective function, wherein the objective function is based on at least one requirement for a safety characteristic and/or for a performance characteristic of the controller and/or of the technical system;
formulating an optimization problem, wherein the optimization problem is formulated based on the objective function and at least one additional condition, wherein the at least one additional condition ensures at least one restriction of at least one state of the technical system; and
calculating the parameterization of the controller based on the formulated optimization problem.

15. The method according to claim 14, wherein:
the at least one state reflects a temporal behavior of a corresponding controlled variable of the controller and indicates a current value of the corresponding controlled variable; and
the restriction of the at least one state of the technical system is ensured by the controller controlling the at least one state in such a way that a value of the at least one state remains in an invariant set.

16. The method according to claim 14, wherein the characteristic of the controller furthermore defines a type of restriction of the state of the technical system, wherein the type is based on an ellipsoid function or a polytope function.

17. The method according to claim 14, wherein the defining of the objective function includes the following step:
determining a limit value or a limit range for the at least one state based on the at least one requirement for the safety characteristic and/or for the performance characteristic of the controller and/or of the technical system.

18. The method according to claim 14, wherein the at least one additional condition furthermore defines a threshold value for the at least one state and/or for at least one input variable of the controller, wherein the defined threshold value according to the additional condition must not be exceeded.

19. The method according to claim 14, wherein the formulating of the optimization problem further comprises the following step:
defining a cost function, wherein the cost function assigns a weighting value to the at least one state as part of calculating the parameterization in order to provide prioritization of states.

20. The method according to claim 14, wherein the at least one differential equation is a linear differential equation and the dynamic behavior of the technical system is represented by a combination of the at least one differential equation with at least one further linear differential equation.

21. The method according to claim 14, wherein the characteristic of the controller is determined in such a way that values of all states or values of some of the states are taken into account.

22. The method according to claim 14, wherein the method further comprises the following step:
implementing the parameterized controller on the technical system, wherein the technical system is a vehicle and the controller is used for lateral and/or longitudinal control of the vehicle.

23. A controller for a technical system, wherein the controller is configured to calculate a parameterization of the controller, the controller configured to:
determine a characteristic of the controller, wherein the characteristic includes at least a description of a structure of the controller, and at least one differential equation to represent a dynamic behavior of the technical system by the differential equation;
define an objective function, wherein the objective function is based on at least one requirement for a safety characteristic and/or for a performance characteristic of the controller and/or of the technical system;
formulate an optimization problem, wherein the optimization problem is formulated based on the objective function and at least one additional condition, wherein the at least one additional condition ensures at least one restriction of at least one state of the technical system; and
calculate the parameterization of the controller based on the formulated optimization problem.

24. A data processing device configured to calculate a parameterization of a controller for a technical system, the data processing device configured to:
determine a characteristic of the controller, wherein the characteristic includes at least a description of a structure of the controller, and at least one differential equation to represent a dynamic behavior of the technical system by the differential equation;
define an objective function, wherein the objective function is based on at least one requirement for a safety characteristic and/or for a performance characteristic of the controller and/or of the technical system;
formulate an optimization problem, wherein the optimization problem is formulated based on the objective function and at least one additional condition, wherein the at least one additional condition ensures at least one restriction of at least one state of the technical system; and
calculate the parameterization of the controller based on the formulated optimization problem.

25. A non-transitory computer-readable storage medium on which are stored commands for calculating a parameterization of a controller for a technical system, the commands, when executed by a computer, causing the computer to perform the following steps:
determining a characteristic of the controller, wherein the characteristic includes at least a description of a structure of the controller, and at least one differential equation to represent a dynamic behavior of the technical system by the differential equation;
defining an objective function, wherein the objective function is based on at least one requirement for a safety characteristic and/or for a performance characteristic of the controller and/or of the technical system;
formulating an optimization problem, wherein the optimization problem is formulated based on the objective function and at least one additional condition, wherein the at least one additional condition ensures at least one restriction of at least one state of the technical system; and
calculating the parameterization of the controller based on the formulated optimization problem
